(19) United States
(12) Patent Application Publication
(10) Pub. No.: US 2017/0246075 A1
(43) Pub. Date: Aug. 31, 2017

(54) AIR BAG AND MASSAGE MACHINE

(71) Applicant: FUJI MEDICAL INSTRUMENTS MFG. CO., LTD., Osaka (JP)

(72) Inventor: Toshihisa YOSHIDA, Osaka-shi (JP)

(73) Assignee: FUJI MEDICAL INSTRUMENTS MFG. CO., LTD., Osaka (JP)

(21) Appl. No.: 15/421,271

(22) Filed: Jan. 31, 2017

(30) Foreign Application Priority Data
Feb. 26, 2016 (JP) 2016-35901

(51) Int. Cl. A61H 9/00; A61H 1/00

(52) U.S. Cl. CPC A61H 9/005; A61H 1/008; A61H 2201/1409; A61H 2203/0425

(57) ABSTRACT

A primary object of the present invention is to provide an air bag and a massage machine which can allow a person to select one of an appropriate pressure massage and an appropriate massage with an air bag. An arm air bag portion 600 includes base bodies 610, 620 each containing a frame and a resin molding product, one or more protruding portions 630 for pressure provided on the base bodies 610, 620 and one or more expansion and contraction bags 640, 650, 660, 670, 690 provided on the base bodies 610, 620 and provided around the one or more protruding portions 630 for pressure. An expansion height of each of the one or more expansion and contraction bags 640, 650, 660, 670, 690 is higher than a protruding height H of each of the one or more protruding portions.

This application claims priority under 35 U.S.C. §119 to Japanese patent application Serial No. 2016-35901, filed Feb. 26, 2016, which is incorporated herein by reference in its entirety.

### FIELD OF INVENTION

The present invention relates to an air bag and a massage machine for providing a massage to a person to be treated.

### BACKGROUND OF THE INVENTION

In JP 2013-46673A (patent document 1), there is disclosed a massage apparatus which can reliably transmit oscillation of supporting means to a target to be oscillated which is at least one of a leg and an arm of a user, thereby providing a desired massage effect.

In JP 2013-22223A (patent document 2), there is disclosed a massage apparatus which can provide a massage with a massage band body to be rolled around an affected area if desired in addition to a massage with a main body of a stationary type massage device by using air as a power source.

In JP 2002-165852A (patent document 3), there is disclosed a massage machine which can easily realize a variety of massage stimuli containing a figure-pressure stimulus.

### SUMMARY OF THE INVENTION

One embodiment of the present invention is an air bag, including: a base portion;

one or more protruding portions for pressure which are provided on the base portion; and

one or more expansion and contraction bags provided on the base portion and provided around the one or more protruding portions,

wherein the one or more expansion and contraction bags are formed so that an expansion height of each of the one or more expansion and contraction bags is equal to or higher than a protruding height of each of the one or more protruding portions.

Another embodiment of the present invention is an air bag, including: a base portion;

one or more expansion and contraction bags provided on the base portion; and

one or more protruding portions for pressure provided in the one or more expansion and contraction bags and on the side of the base portion.

### BRIEF DESCRIPTION OF DRAWINGS

FIG. 1 is a perspective view showing a configuration of a massage machine according to an embodiment of the present invention.

FIG. 2 is a schematic view showing one example of configurations of an arm treatment portion and an arm air bag portion.

FIG. 3 is another schematic view showing the one example of the configurations of the arm treatment portion and the arm air bag portion.

FIG. 4 is a schematic view showing one example of a protruding portion for pressure and an expansion and contraction bag.

FIG. 5 is a schematic view showing another example of the arm air bag portion.

FIG. 6 is a schematic view showing another example of the arm air bag portion.

FIG. 7 is a schematic view showing another example of the arm air bag portion.

FIG. 8 is a schematic view showing another example of the arm air bag portion.

FIG. 9 is a schematic view showing another example of the arm air bag portion.

FIG. 10 is a schematic view showing another example of the arm air bag portion.

FIG. 11 is a schematic view showing another example of the arm air bag portion.

FIG. 12 is a schematic view showing another example of the arm air bag portion.

FIG. 13 is a schematic view showing another example of the arm air bag portion.

FIG. 14 is a schematic view showing another example of the arm air bag portion.

FIG. 15 is a schematic view showing another example of the arm air bag portion.

### DETAILED DESCRIPTION OF THE PREFERRED EMBODIMENT

Hereinafter, embodiments of the present invention will be described in detail with reference to the accompanying drawings. In this regard, the same numbers are used throughout the drawings to reference the same objects or the equivalent objects and description for the same objects or the equivalent objects is not repeated. For ease of explanation, configurations are shown in the drawings referenced in the following description in a simplified or schematized manner and/or some of configuration members are omitted in the drawings. Further, a dimensional ratio among the configuration members shown in each drawing does not necessarily indicate an actual dimensional ratio.

### Embodiment

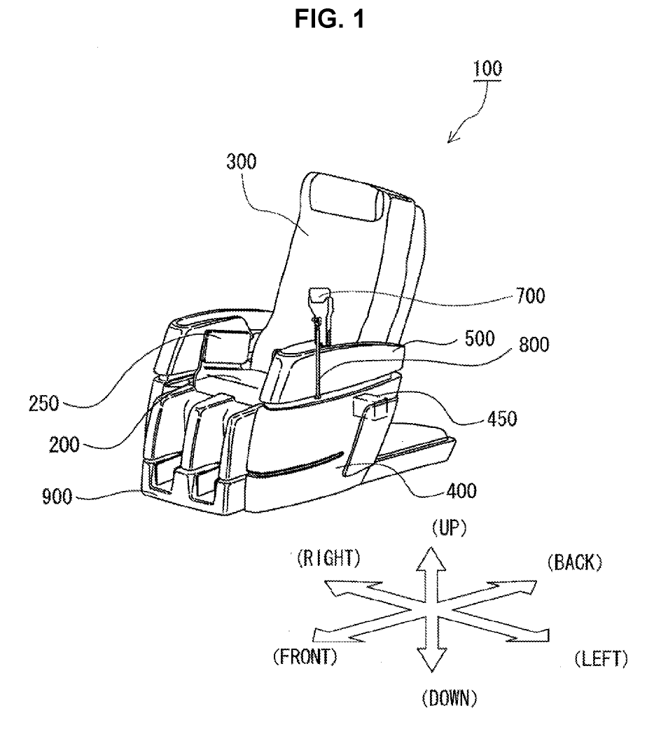

FIG. 1 is a perspective view showing a configuration of a massage machine 100 according to an embodiment of the present invention.

As shown in FIG. 1, the massage machine 100 according to the embodiment of the present invention includes a seat portion 200, a backrest portion 300, a base portion 400, a control part 450, arm treatment portions 500, an operation part 700, a stand 800 and a leg placing portion 900.

In this regard, in the following description for the massage machine 100, the side on which the backrest portion 300 is formed on the seat portion 200 is assumed as a back side (BACK), the side opposed to the back side (BACK) is assumed as a front side (FRONT), each of a left side (LEFT) and a right side (RIGHT) is assumed and each of an upside (UP) and a down side (DOWN) is assumed as shown in FIG. 1.

As shown in FIG. 1, the backrest portion 300 of the massage machine 100 is formed so that the backrest portion 300 can support a shoulder, a waist and a back of the person to be treated and can be erected and tilted in the front-back direction. Further, massage elements (a pair of massage balls) are provided in the backrest portion 300 so that the massage elements can be moved in the up-down direction along a guide rail. The massage elements are constituted of the pair of massage balls so as to be capable of providing a variety of treatment operations such as a kneading operation, a beating operation and a rolling operation.

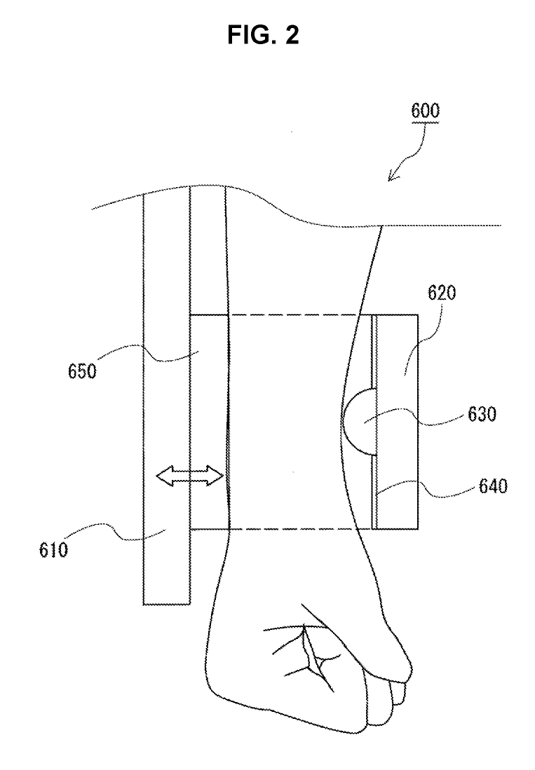

Further, as shown in FIG. 1, the arm treatment portions 500 are respectively provided to stand on the left and right sides on the seat portion 200. One or more expansion and contraction bags (see FIGS. 2 to 13), which can repeatedly expand, of an after-mentioned arm air bag portion 600 (see FIGS. 2 to 13) are provided in each of the arm treatment portions 500. Each of the arm treatment portions 500 provides treatment to each arm of the person to be treated with supporting each arm of the person to be treated by using the expansion and contraction bags.

Further, one or more expansion and contraction bags (air treatment portions), which can repeatedly expand and are the same as those of the arm air bag portion 600, are provided in waist air bag portions 250 provided to stand on the seat portion 200 shown in FIG. 1. Each of the waist air bag portions 250 provides treatment to a hip of the person to be treated with supporting the hip of the person to be treated by using the expansion and contraction bags. Further, the leg placing portion 900 is axially supported at front ends of the seat portion 200 and the base portion 400 and provided so that the leg placing portion 900 itself can be pivotally moved. One or more expansion and contraction bags (not shown in the drawings), which can repeatedly expand and are the same as those of the arm air bag portion 600, are provided in the leg placing portion 900. The leg placing portion 900 provides treatment to legs of the person to be treated by using the expansion and contraction bags.

Further, the control part 450 controls operations of the pair of massage elements and the one or more expansion and contraction bags of the waist air bag portions 250, the arm treatment portions 500 and the leg placing portion 900. In particular, in this embodiment, the control part 450 can individually operate the plurality of expansion and contraction bags.

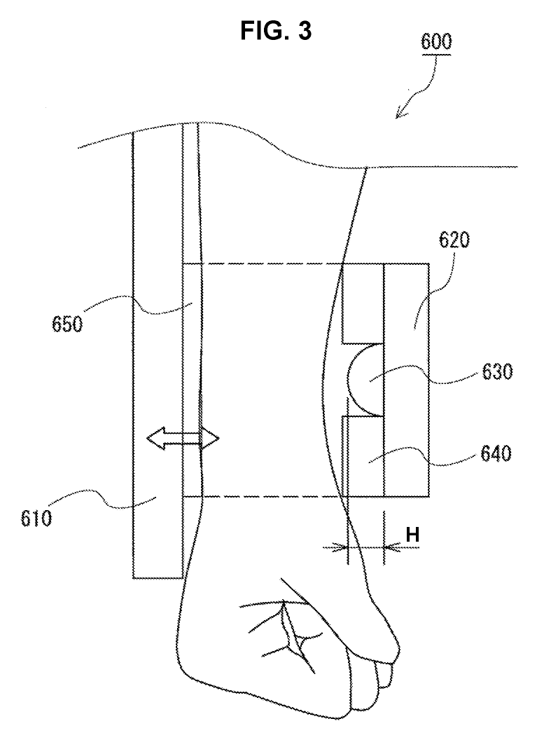

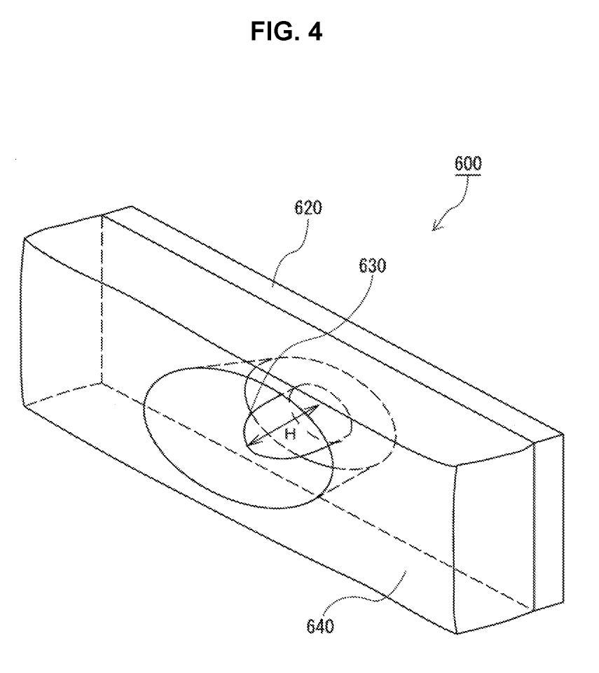

Next, description will be given to configurations of the arm treatment portion 500 and the arm air bag portion 600 according to this embodiment. Each of FIGS. 2 and 3 is a schematic view showing one example of the configurations of the arm treatment portion 500 and the arm air bag portion 600. FIG. 4 is a schematic view showing one example of a protruding portion 630 for pressure and an expansion and contraction bag 640.

In the following description, among the arm treatment portions 500 respectively provided on the left and right sides, only the arm treatment portion 500 provided on the right side will be described.

As shown in FIG. 2, in the arm air bag portion 600 of the arm treatment portion 500, frames to be a base or resin assemblies 610, 620 (hereinafter, referred to as base bodies) attached to the frames are provided so as to face each other.

As shown in FIGS. 2 and 3, an expansion and contraction bag 650 is provided on the base body 610. Further, as shown in FIGS. 2 and 4, the protruding portion 630 for pressure and the expansion and contraction bag 640 are provided on the base body 620.

The protruding portion 630 for pressure provided on the base body 620 shown in FIG. 4 is constituted of a semispherical resin product having a height H of 2 cm or less, for example. In this regard, the protruding portion 630 for pressure is not limited to the resin product. The protruding portion 630 for pressure may be constituted of an elastic body, a rubber or the like. Further, although it is described that the height H is 2 cm or less, the height H is not limited thereto and the height H may be any other arbitrary value. Further, as shown in FIG. 4, the expansion and contraction bag 640 is provided around the protruding portion 630 for pressure. The expansion and contraction bag 640 is formed so that a height of the expansion and contraction bag 640 is higher than the height H of the protruding portion 630 for pressure (equal to or more than H) when the expansion and contraction bag 640 is expanded.

For example, in the case where the person to be treated hopes to receive the pressure massage, the control part 450 repeatedly expands the expansion and contraction bag 650 of the base body 610 as shown in FIG. 2. Hereinafter, the words of “repeatedly expand” mean to repeat expansion and contraction at predetermined intervals. As a result, a hand of the person to be treated is pressed onto the protruding portion 630 for pressure provided on the base body 620 by the expansion and contraction bag 650. As a result, the person to be treated can receive the pressure massage.

Next, in the case where the person to be treated hopes to receive not the pressure massage but a massage with the expansion and contraction bags 640, 650, the control part 450 repeatedly expands the expansion and contraction bag 650 of the base body 610 and keeps a state that the expansion and contraction bag 640 of the base body 620 is expanded as shown in FIG. 3. As a result, the person to be treated can receive not the pressure massage but the massage with the expansion and contraction bags 640, 650. Further, since it is unnecessary to form holes in the base bodies 610, 620, there is no risk that a body of the person to be treated is pinched in the holes and there is no place into which dusts enter. Thus, it is also possible to easily clean up.

### (Another Example of the Arm Air Bag Portion)

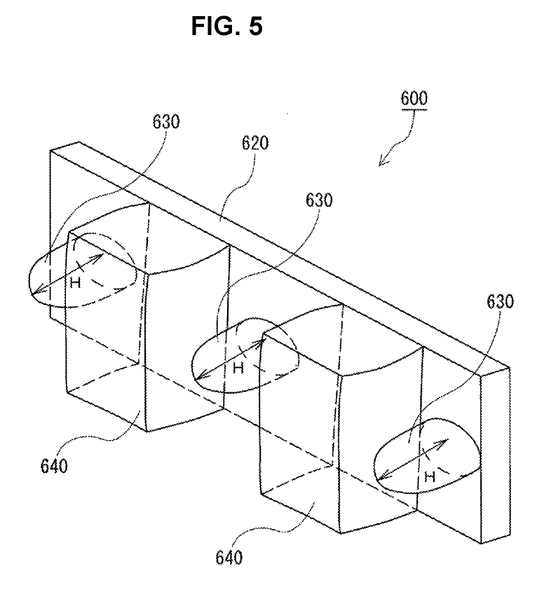

FIG. 5 is a schematic view showing another example of the arm air bag portion 600 shown in FIGS. 2 to 4.

As shown in FIG. 5, in the arm air bag portion 600, a plurality of protruding portions 630 for pressure are provided on the base body 620 and a plurality of expansion and contraction bags 640 are provided between the plurality of protruding portions 630 for pressure.

### (Yet Another Example of the Arm Air Bag Portion)

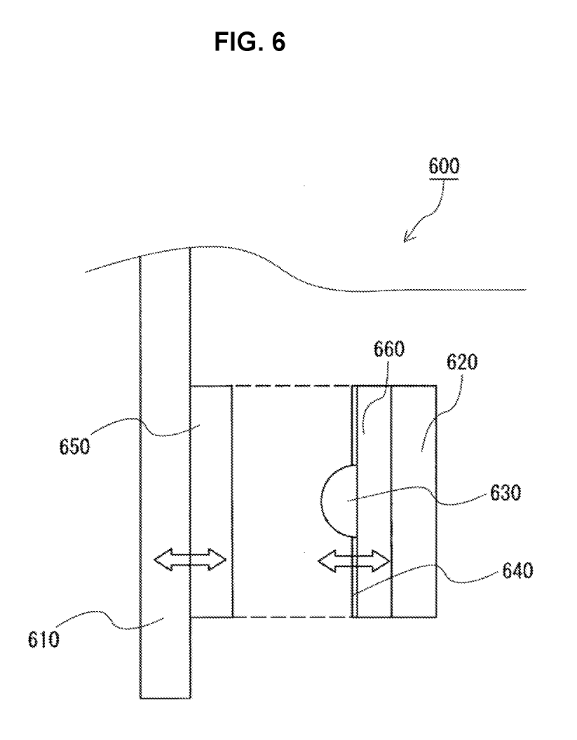

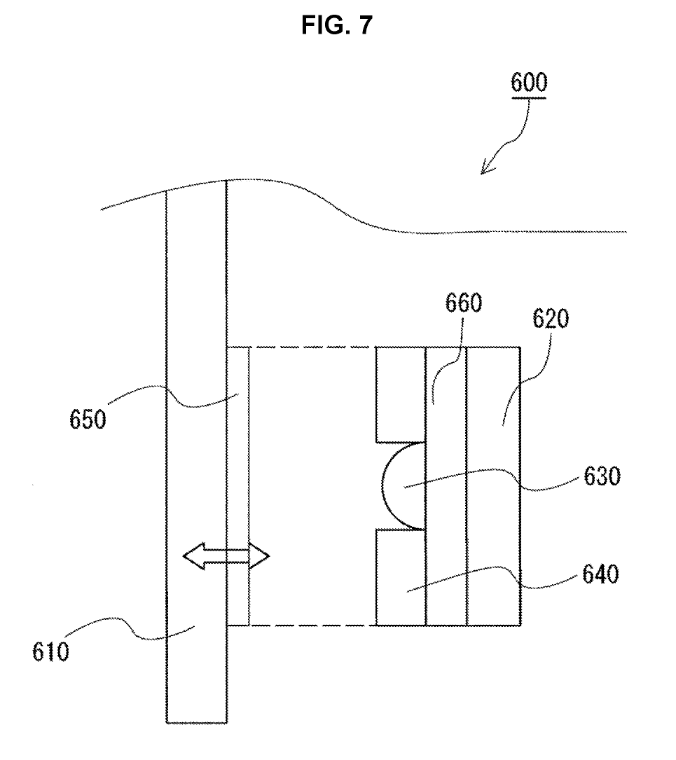

Each of FIGS. 6 and 7 is a schematic view showing another example of the arm air bag portion 600 shown in FIGS. 2 to 5.

As shown in FIGS. 6 and 7, the expansion and contraction bag 650 is provided on the base body 610 of the arm air bag portion 600. Further, as shown in FIGS. 6 and 7, an expansion and contraction bag 660 is provided on the base body 620 and the protruding portion 630 for pressure is provided so as to be laminated on the expansion and contraction bag 660. Further, the expansion and contraction bag 640 is provided around the protruding portion 630 for pressure.

In the case where the person to be treated hopes to receive the pressure massage, the control part 450 repeatedly expands the expansion and contraction bag 650 of the base body 610 as shown in FIG. 6. Further, the control part 450 repeatedly expands the expansion and contraction bag 660 and keeps a state that the expansion and contraction bag 640 is contracted. As a result, the hand of the person to be treated is pressed onto the protruding portion 630 for pressure provided on the base body 620 and the expansion and contraction bag 660 by the expansion and contraction bags 650, 660. As a result, the person to be treated can receive the pressure massage.

Next, in the case where the person to be treated hopes to receive not the pressure massage but a massage with the expansion and contraction bags 640, 650, the control part 450 repeatedly expands the expansion and contraction bag 650 of the base body 610 and keeps a state that the expansion and contraction bag 640 of the base body 620 is expanded as shown in FIG. 7. As a result, the person to be treated can receive not the pressure massage but the massage with the expansion and contraction bags 640, 650. Further, since it is unnecessary to form holes in the base bodies 610, 620, there is no risk that the body of the person to be treated is pinched in the holes and there is no place into which dusts enter. Thus, it is also possible to clean up.

### (Yet Another Example of the Arm Air Bag Portion)

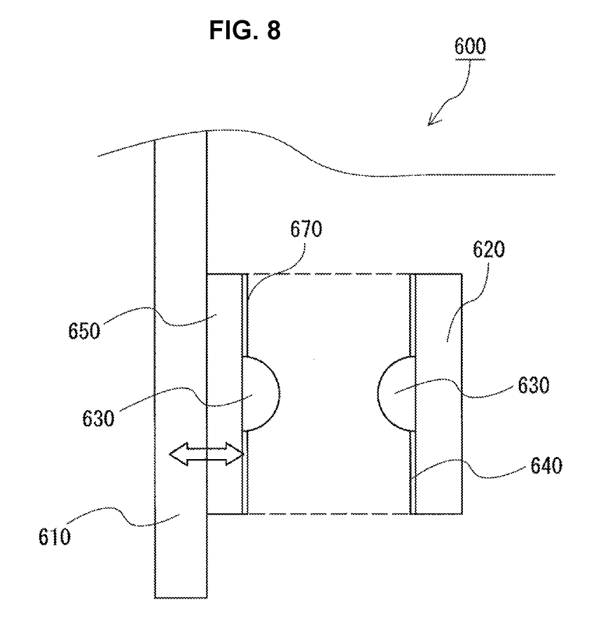

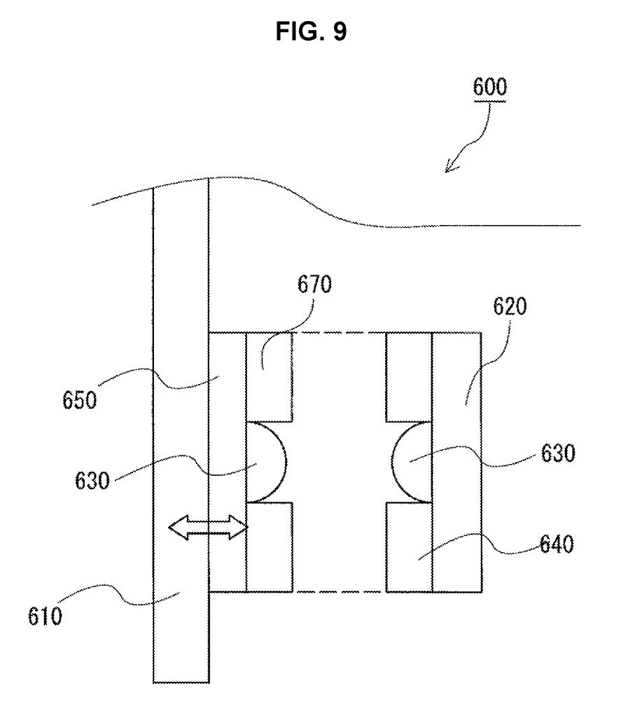

Each of FIGS. 8 and 9 is a schematic view showing yet another example of the arm air bag portions 600 shown in FIGS. 2 to 7.

As shown in FIGS. 8 and 9, the expansion and contraction bags 650, 670 and the protruding portion 630 for pressure are provided on the base body 610 of the arm air bag portion 600. The expansion and contraction bag 670 is provided around the protruding portion 630 for pressure on the side of the base body 610. Further, as shown in FIGS. 8 and 9, the protruding portion 630 for pressure is provided on the base body 620 and the expansion and contraction bag 640 is provided around the protruding portion 630 for pressure on the base body 620.

In the case where the person to be treated hopes to receive the pressure massage, the control part 450 repeatedly expands the expansion and contraction bag 650 of the base body 610 and keeps a state that the expansion and contraction bag 670 is contracted as shown in FIG. 8. Further, the control part 450 keeps a state that the expansion and contraction bag 640 is contracted. As a result, the hand of the person to be treated is pressed onto the protruding portions 630 for pressure provided on the base body 620 and the expansion and contraction bag 650 by the expansion and contraction bag 650. As a result, the person to be treated can receive the pressure massage.

Next, in the case where the person to be treated hopes to receive not the pressure massage but a massage with the expansion and contraction bags 640, 650, 670, the control part 450 repeatedly expands the expansion and contraction bag 650 of the base body 610 and keeps a state that the expansion and contraction bag 670 of the base body 610 is expanded as shown in FIG. 9. Further, the control part 450 keeps a state that the expansion and contraction bag 640 of the base body 620 is expanded. As a result, the person to be treated can receive not the pressure massage but the massage with the expansion and contraction bags 640, 650, 670.

### (Yet Another Example of the Arm Air Bag Portion)

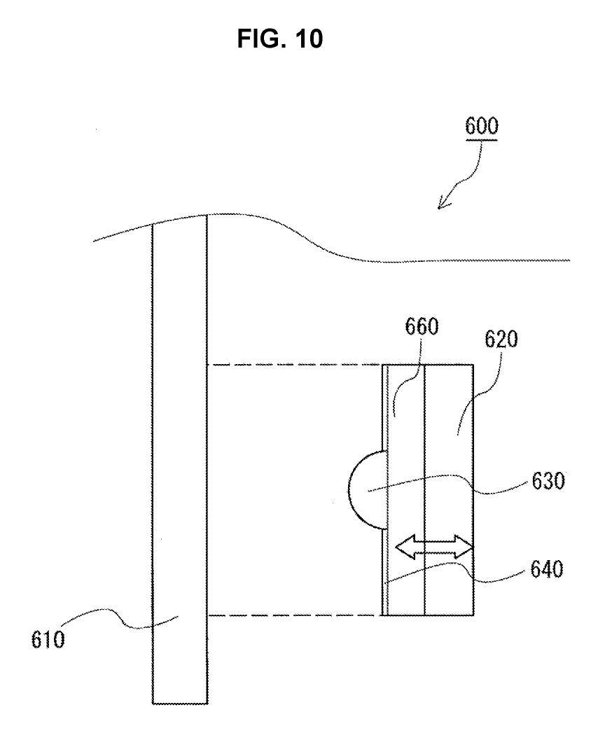

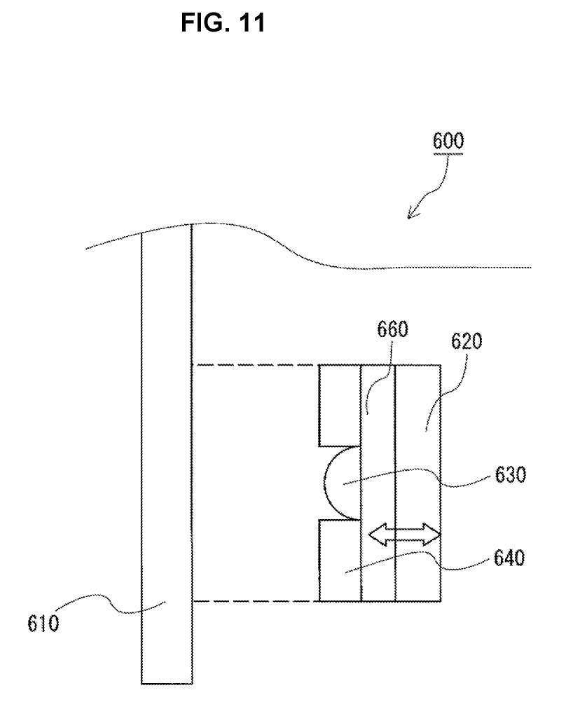

Each of FIGS. 10 and 11 is a schematic view showing another example of the arm air bag portions 600 shown in FIGS. 2 to 9.

As shown in FIGS. 10 and 11, the expansion and contraction bag and the protruding portion for pressure are not provided on the base body 610 of the arm air bag portion 600. Further, as shown in FIGS. 10 and 11, the expansion and contraction bag 660 is provided on the base body 620 and the protruding portion 630 for pressure is provided so as to be laminated on the expansion and contraction bag 660. Further, the expansion and contraction bag 640 is provided around the protruding portion 630 for pressure.

In the case where the person to be treated hopes to receive the pressure massage, the control part 450 keeps a state that the expansion and contraction bag 640 is contracted and repeatedly expands the expansion and contraction bag 660 as shown in FIG. 10. As a result, the hand of the person to be treated is pressed onto the protruding portion 630 for pressure provided on the expansion and contraction bag 660. As a result, the person to be treated can receive the pressure massage.

Next, in the case where the person to be treated hopes to receive not the pressure massage but a massage with the expansion and contraction bags 640, 660, the control part 450 repeatedly expands the expansion and contraction bag 660 of the base body 620 and keeps a state that the expansion and contraction bag 640 of the base body 620 is expanded as shown in FIG. 11. As a result, the person to be treated can receive not the pressure massage but the massage with the base body 610 and the expansion and contraction bags 640, 660.

### (Another Example of the Arm Air Bag Portion 600)

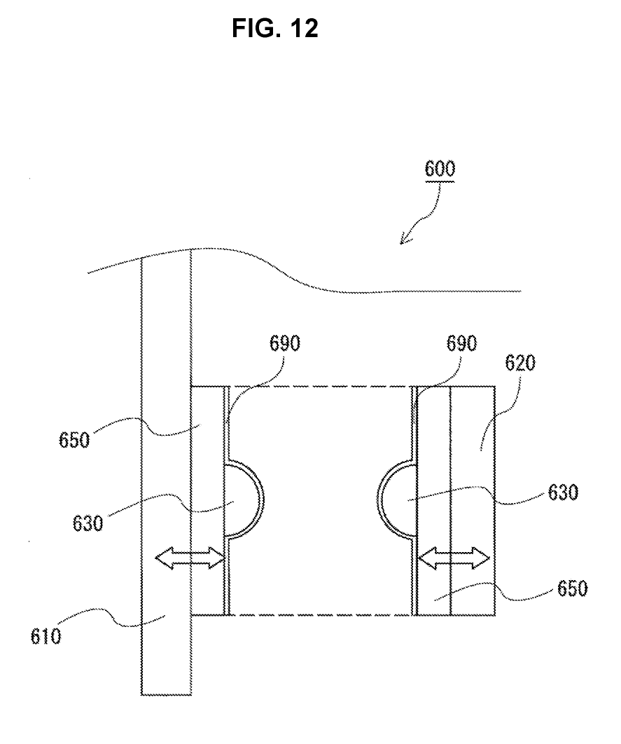

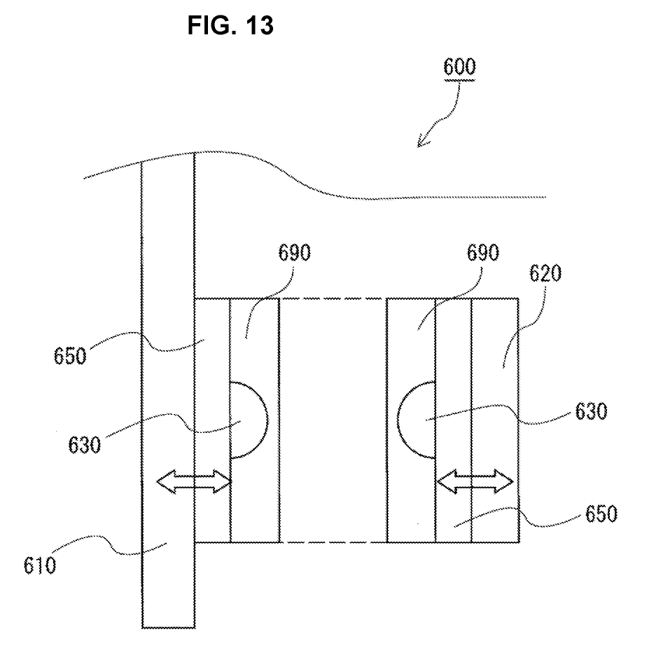

Each of FIGS. 12 and 13 is a schematic view showing yet another example of the arm air bag portions 600 shown in FIGS. 2 to 11.

As shown in FIGS. 12 and 13, in the base body 610 of the arm air bag portion 600, an expansion and contraction bag 690 and the protruding portion 630 for pressure are provided so as to be laminated on the expansion and contraction bag 650. Further, the protruding portion 630 for pressure is provided in the expansion and contraction bag 690. Further, as shown in FIGS. 12 and 13, in the base body 620, the expansion and contraction bag 690 and the protruding portion 630 for pressure are provided so as to be laminated on the expansion and contraction bag 650. Furthermore, the protruding portion 630 for pressure is provided in the expansion and contraction bag 690.

In the case where the person to be treated hopes to receive the pressure massage, the control part 450 repeatedly expands the expansion and contraction bags 650 of the base bodies 610, 620 and keeps a state that the expansion and contraction bags 690 are contracted as shown in FIG. 12. As a result, the hand of the person to be treated is pressed onto the protruding portions 630 for pressure provided on the expansion and contraction bags 650 by the expansion and contraction bags 650. As a result, the person to be treated can receive the pressure massage.

Nest, in the case where the person to be treated hopes to receive not the pressure massage but a massage with the expansion and contraction bags 690, the control part 450 repeatedly expands the expansion and contraction bags 650 of the base bodies 610, 620 and keeps a state that the expansion and contraction bags 690 of the base bodies 610, 620 are expanded as shown in FIG. 13. As a result, the person to be treated can receive not the pressure massage but the massage with the expansion and contraction bags 650, 690.

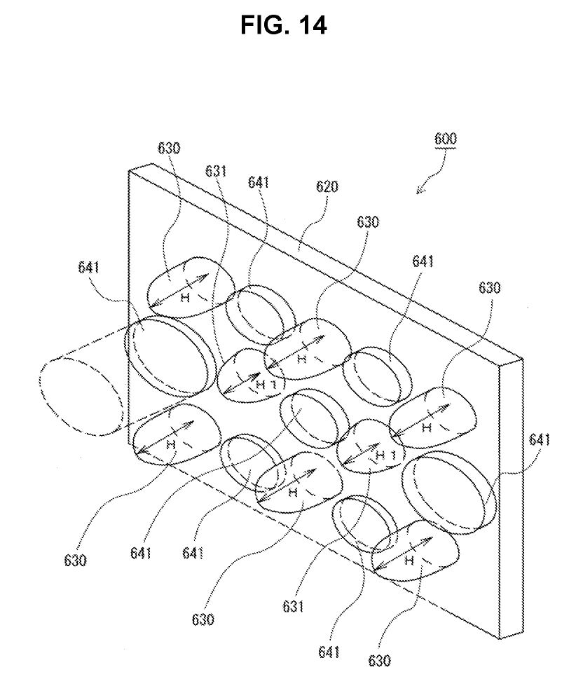

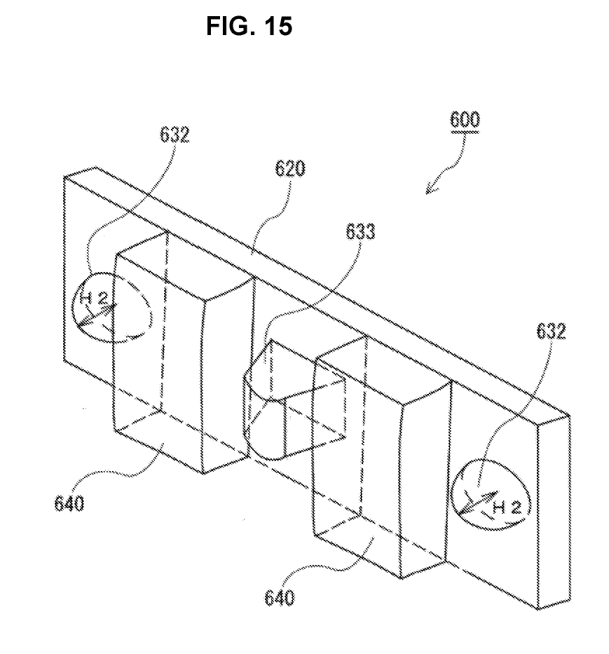

FIG. 14 is a schematic view showing another example of the arm air bag portion 600. FIG. 15 is a schematic view showing another example of the arm air bag portion 600.

First, as shown in FIG. 14, the arm air bag portion 600 is formed from a plurality of protruding portions 630 for pressure and a plurality of protruding portions 631 for pressure which are arranged in a zigzag pattern. Each of the plurality of protruding portions 630 for pressure is constituted of a semispherical resin product having a height H of 2 cm or less, for example. Further, each of the plurality of protruding portions 631 for pressure is constituted of a semispherical resin product having a height H1 of 1 cm or less, for example. In this regard, the protruding portions 630, 631 for pressure are not limited to the resin product. The protruding portions 630, 631 for pressure may be constituted of an elastic body, a rubber or the like. Further, although it is described that the height H is 2 cm or less and the height H1 is 1 cm or less, the heights H, H1 are not limited thereto and the heights H, H1 may be any other arbitrary values.

Further, expansion and contraction bags 641 are arranged between the plurality of protruding portions 630 for pressure and the plurality of protruding portions 631 for pressure. Each expansion and contraction bag 641 is formed so that each expansion and contraction bag 641 has a cylindrical shape at the time of expansion and has a height at the time of expansion equal to or higher than H. Further, as shown in FIG. 14, a dotted line for a part of the expansion and contraction bags 641 indicates a state that this expansion and contraction bag 641 is expanded.

Next, as shown in FIG. 15, in the arm air bag portion 600, a plurality of protruding portions 632 for pressure and a plurality of protruding portions 633 for pressure are formed. Further, expansion and contraction bags 640 are respectively formed between the protruding portions 632 for pressure and the protruding portions 633 for pressure.

Each of the plurality of protruding portions 632 for pressure is constituted of a semispherical resin product having a height H2 of 0.8 cm or less, for example. In this regard, each protruding portion 632 for pressure is not limited to the resin product. Each protruding portion 632 for pressure may be constituted of an elastic body, a rubber or the like. Further, although it is described that the height H2 is 0.8 cm or less, the height H2 is not limited thereto and the height H2 may be any other arbitrary value. Further, each protruding portion 633 for pressure is constituted of a truncated quadrangular pyramid body, specifically, is mainly constituted of a trapezoidal column body. In this regard, an upper surface of each protruding portion 633 for pressure is formed into a curved surface as shown in FIG. 15. This configuration is intended to avoid giving pain at the time of the treatment to the person to be treated. Each protruding portion 633 for pressure is constituted of a resin product having a height H2 of 0.8 cm or more, for example. In this regard, each protruding portion 633 for pressure is not limited to the resin product. Each protruding portion 633 for pressure may be constituted of an

Further, an expansion height of each of the plurality of expansion and contraction bags 640, 641, 650, 660, 670, 690 means a height in a state that the skin of the person to be treated does not make contact with each expansion and contraction bag, that is a state that supplying gas into each of the expansion and contraction bags 640, 641, 650, 660, 670, 690 is performed and force caused from the contact with the person to be treated is not applied to each expansion and contraction bag. As a result, in the case where external force is applied to the expansion and contraction bags 640, 641, 650, 660, 670, 690, that is the case of providing the massage with the expansion and contraction bags 640, 641, 650, 660, 670, 690 to the person to be treated, since the expansion and contraction bags 640, 641, 650, 660, 670, 690 are pressed and the height of each of the expansion and contraction bags 640, 641, 650, 660, 670, 690 decreases, there is a case where the heights H, H1, H2 of the respectively corresponding protruding portions 630, 631, 632, 633 for pressure are higher than the heights of the expansion and contraction bags 640, 641, 650, 660, 670, 690 by several millimeters.

In this regard, the arm air bag portion 600 can be applied to not only the massage machine 100 but also other massage machines. Further, the same configuration as that of the arm air bag portion 600 may be applied to any arbitrary portions such as the leg placing portion 900 and the waist air bag portion 250 or any arbitrary positions. Further, although the press massage is explained in the above description, it should be noted that the press massage is a superordinate concept of the finger-pressure massage and the press massage contains the finger-pressure massage. Thus, each of the protruding portions 630, 631, 632, 633 for pressure contains a protruding portion for finger-pressure.

As described above, in the case of providing the massage with the one or more protruding portions 630 for pressure by using the arm air bag portion 600 and the massage machine 100 according to this embodiment, it is possible to provide the pressure massage with the one or more protruding portions 630 for pressure to the person to be treated by contracting the one or more expansion and contraction bags 640, 670, 690. On the other hand, in the case of not providing the massage with the one or more protruding portions 630 for pressure, it is possible to allow the body of the person to be treated to receive the massage with the one or more expansion and contraction bags 640, 670, 690 provided around the protruding portions 630 for pressure by expanding the one or more expansion and contraction bags 640, 670, 690.

Further, in the arm air bag portion 600 shown in FIGS. 6 and 7, since the one or more expansion and contraction bags 660 are provided between the one or more protruding portions 630 for pressure and the base body 620, it is possible to move the one or more protruding portions 630 for pressure by repeatedly expanding each expansion and contraction bag 660 to apply appropriate pressure to the person to be treated.

Further, as shown in FIGS. 2 and 3, among the base bodies 610, 620 provided so as to face each other, the one or more protruding portions 630 are provided on the one base body 620 and the one or more expansion and contraction bags 650 are provided on the other base body 610. Thus, in the case where the person to be treated hopes to receive the pressure massage, it is possible to provide the pressure massage to the person to be treated by expanding the one or more expansion and contraction bags 650 on the other base body 610. In the case where the person to be treated hopes to receive the massage with the expansion and contraction bags, it is possible to prevent the body of the person to be treated from being contacted with the one or more protruding portions 630 for pressure by expanding the one or more expansion and contraction bags 640 provided around the one or more protruding portions 630 for pressure on the one base body 610. As a result, it is possible to provide the massage with the expansion and contraction bags to the person to be treated.

Further, as shown in FIGS. 12 and 13, in the case where the person to be treated hopes to receive the pressure massage, the person to be treated can receive the pressure massage with the one or more protruding portions 630 for pressure without expanding the one or more expansion and contraction bags 690. On the other hand, in the case where the person to be treated hopes to receive the massage with the expansion and contraction bags, it is possible to prevent the body of the person to be treated from being contacted with the one or more protruding portions 630 for pressure by expanding the one or more expansion and contraction bags 690. As a result, it is possible to provide the massage with the expansion and contraction bags to the person to be treated.

### (Correspondence Relationships Among Each Portion in the Embodiments and Each Constituent Element in the Claims)

In the present invention, the massage machine 100 corresponds to “a massage machine”, the base bodies 610, 620 correspond to “base portions”, the protruding portions 630, 631, 632, 633 for pressure correspond to “one or more protruding portions for pressure”, the expansion and contraction bags 640, 641, 650, 660, 670, 690 correspond to “one or more expansion and contraction bags”, the height H or more, the height H1 or more and the height H2 or more correspond to “an expansion height of each of the one or more expansion and contraction bags”, the height H, the height H1 and the height H2 correspond to “a protruding height of each of the one or more protruding portions”, the arm air bag portion 600 corresponds to “an air bag”, the base body 610 corresponds to “one of the base portions”, the base body 620 corresponds to “the other one of the base portions” and the words of “in the expansion and contraction bags 690” correspond to “in the one or more expansion and contraction bags”.

Although the preferred embodiment of the present invention is described above, the present invention is not limited thereto. It would be understood that a variety of embodiments can be practiced without departing from the spirit and scope of the present invention. Further, the functions and effects provided by the configuration of the present invention have been described in this embodiment, these functions and effects are merely one example and do not limit the present invention.

In the patent documents 1 to 3, there is disclosed a massage machine related to a finger-pressure massage. However, the massage machine has a structure for allowing protruding portions for finger-pressure to be moved into and out from the structure and a hole is formed in the structure. This hole is structurally unsuitable from a view point of user application. Further, in a state that the protruding portions for finger-pressure are always protruded from the structure, there is a problem in the case where a person to be treated feels that finger-pressure with the protruding portions is unnecessary.

A primary object of the present invention is to provide an air bag and a massage machine which can allow the person to be treated to receive an appropriate pressure massage in the case where the person to be treated hopes to receive a pressure massage and an appropriate massage with an air bag in the case where the person to be treated hopes to receive a massage with the air bag.

(1) An air bag according to one aspect of the present invention involves a base portion, one or more protruding portions for pressure which are provided on the base portion and one or more expansion and contraction bags provided on the base portion and provided around the one or more protruding portions wherein the one or more expansion and contraction bags are formed so that an expansion height of each of the one or more expansion and contraction bags is equal to or higher than a protruding height of each of the one or more protruding portions.

In this case, in the case of providing a massage with the one or more protruding portions for pressure, it is possible to press a person to be treated with the one or more protruding portions for pressure by contracting the one or more expansion and contraction bags. On the other hand, in the case of not providing the massage with the one or more protruding portions, it is possible to allow the protruding portions not to substantially make contact with a body of the person to be treated by expanding the one or more expansion and contraction bags. Thus, the person to be treated can receive a massage other than the massage with pressure, which is provided by the one or more expansion and contraction bags provided around the one or more protruding portions. Therefore, it is possible to respond to a variety of needs of the person to be treated. Here, the term “pressure” does not mean pressure mainly caused by gas and the like but pressure caused by a solid body.

Further, the said expansion height of each of the one or more expansion and contraction bags means a height of each of the one or more expansion and contraction bags in a state that the one or more expansion and contraction bags do not make contact with a skin of the person to be treated. Namely, the said expansion height of each of the one or more expansion and contraction bags means a height of each of the one or more expansion and contraction bags in a state that only internal pressure is applied to each expansion and contraction bag and external force (force caused by the contact with the person to be treated) is not applied to each expansion and contraction bag.

As a result, in the case where the external force is applied to each expansion and contraction bag, that is, in the case of providing the massage with each expansion and contraction bag to the person to be treated, each expansion and contraction bag is pressed and the height of each expansion and contraction bag decreases, thus there is a case where the height of each protruding portion becomes higher than the height of each expansion and contraction bag by several millimeters. In this regard, even in the case where the height of each protruding portion is higher than the height of each expansion and contraction bag by several millimeters, it goes without saying that pressure applied to the person to be treated by each protruding portion remains in a level that the person to be treated cannot feel the pressure massage with each protruding portion.

(2) An air bag of a second present invention according to the air bag of the one aspect, wherein one or more expansion and contraction bags may be provided between the one or more protruding portions and the base portion.

In this case, since the one or more expansion and contraction bags are provided between the one or more protruding portions and the base portion, it is possible to move the one or more protruding portions for pressure, thereby applying appropriate pressure to the person to be treated.

(3) An air bag of a third present invention according to the air bag of the one aspect or the second present invention, wherein the base portion contains two base portions respectively provided at positions facing each other, the one or more protruding portions are provided on at least one of the base portions and the one or more expansion and contraction bags are provided on at least the other one of the base portions.

In this case, among the base portions provided so as to face each other, the one or more protruding portions are provided on the one of the base portions and the one or more expansion and contraction bags are provided at positions on the other one of the base portions respectively facing the one or more protruding portions. Thus, in the case where the person to be treated hopes to receive the pressure massage, it is possible to provide the pressure massage to the person to be treated by expanding the one or more expansion and contraction bags on the other one of the base portions.

Further, in the case where the person to be treated hopes to receive the massage with each expansion and contraction bag, it is possible to prevent the body of the person to be treated from being contacted with the one or more protruding portions by expanding the one or more expansion and contraction bags provided around the one or more protruding portions on the one of the base portions. As a result, it is possible to provide the massage with each expansion and contraction bag to the person to be treated. Further, it is possible to select one of the pressure massage and the massage with each expansion and contraction bag, thereby responding to a variety of needs of the person to be treated.

(4) An air bag according to another present invention involves a base portion, one or more expansion and contraction bags provided on the base portion and one or more protruding portions for pressure provided in the one or more expansion and contraction bags and on the side of the base portion.

In this case, in the case where the person to be treated hopes to receive the massage with the pressure, the person to be treated can receive the massage with the one or more protruding portions without expanding the one or more expansion and contraction bags. On the other hand, in the case where the person to be treated hopes to receive the massage with each expansion and contraction bag, it is possible to prevent the body of the person to be treated from being contacted with the one or more protruding portions by expanding the one or more expansion and contraction bags. As a result, it is possible to provide the massage with each expansion and contraction bag to the person to be treated.

(5) A massage machine according to yet another present invention comprises the air bag recited in any one of above inventions.

In this case, in the case of providing the massage with the one or more protruding portions for pressure, it is possible to press the person to be treated with the one or more protruding portions for pressure by contracting the one or more expansion and contraction bags. On the other hand, in the case of not providing the massage with the one or more protruding portions, it is possible to prevent the body of the person to be treated from being contacted with each protruding portion by expanding the one or more expansion and contraction bags. Thus, the person to be treated can receive the massage other than the massage with the pressure, which is provided by the one or more expansion and contraction bags provided around the one or more protruding portions.

What is claimed is:

1. An air bag, comprising:
a base portion;
one or more protruding portions for pressure which are provided on the base portion; and
one or more expansion and contraction bags provided on the base portion and provided around the one or more protruding portions,
wherein the one or more expansion and contraction bags are formed so that an expansion height of each of the one or more expansion and contraction bags is equal to or higher than a protruding height of each of the one or more protruding portions.

2. The air bag according to claim 1, wherein one or more expansion and contraction bags are provided between the one or more protruding portions and the base portion.

3. The air bag according to claim 1, wherein the base portion contains two base portions respectively provided at positions facing each other,
wherein the one or more protruding portions are provided on at least one of the base portions, and
wherein the one or more expansion and contraction bags are provided on at least the other one of the base portions.

4. An air bag, comprising:
a base portion;
one or more expansion and contraction bags provided on the base portion; and
one or more protruding portions for pressure provided in the one or more expansion and contraction bags and on the side of the base portion.

5. A massage machine, comprising the air bag recited in claim 1.
